(19) United States
(12) Patent Application Publication
(10) Pub. No.: US 2007/0091371 A1
(43) Pub. Date: Apr. 26, 2007

(54) Image forming device

(76) Inventor: Tomoyoshi Sugihara, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,105

(22) Filed: Oct. 26, 2005

(51) Int. Cl. G06K 15/00

(52) U.S. Cl. 358/1.18

(57) ABSTRACT

A photocopier 1 according to this embodiment of the invention automatically detects the position of a staple 52 from the image data of the front page 51 of a bound original document 50; automatically sets a replacement area for the staple 52 portion or binding margin 54 portion to be replaced according to the position of the staple 52, and a replacement color that is the color of the mask data element substituted for the data element of the replacement area, based on the image data for each page of the original document 50; and then converts the data element of the replacement area portion of the original document 50 image data to the mask data element of the replacement color before printing copies.

### FIELD OF THE INVENTION

The present invention relates generally to an image forming device such as a photocopier or facsimile machine, and relates more particularly to copying an original document that is bound or fastened together with staples or binder clips.

### BACKGROUND INFORMATION

Conventional image forming devices are used to process original documents of various types, including bound documents having multiple pages held together by staples, binder clips and other types of mechanical fasteners. Such multipage original documents are also often copied while the pages are held together by a staple, clip, or other fastener. As a result, when an original document having the pages held together with a staple, for example, is copied, an image of the staple is also printed on the copy of the front page. In addition, when the second and later pages are folded back for copying, a gap is formed between the original document page being copied and the binding margin where the pages are folded. This causes the area near the binding margin to be copied in a different color than the neighboring part of the page. When using an image forming device that produces monochrome copies, for example, a shadow is cast at the binding margin part of the original document, and this shadow is reproduced as a black area on the copy. To prevent this, some image forming devices enable the user to define a substantially triangular area at the corner portion where the original document is bound so that during copying the image forming device converts black image data in this area to white image data and reproduces the binding margin area in white.

Although not directly related to the solution described above, another image forming device known from the literature has a means for recognizing and storing the location of the staple in a stapled original document from the image data of the original document, and automatically applies a staple process to the same location as the staple in the original document without requiring the user to specify where the original document is stapled.

The first image forming device described above can certainly print the binding margin part of the original document on paper in white without removing the staples or clips from the original document for copying, without reproducing an image of the staple or clip in the copy, and without printing the binding margin part

However, operating the first image forming device described above is difficult because the image forming device does not automatically detect the location of the staple or the binding margin area, and thus requires the user to define where the binding margin is located. Furthermore, when copying the front page of a stapled original document, the specified binding margin part is printed white and the part other than the staple is therefore also printed white. Furthermore, if the color of the area around the binding margin is not white, the area of the binding margin on the copied page is reproduced in a different color than the neighboring area, and making a photocopy that looks good is thus not possible.

The present invention is directed to solving this problem, and an object of the invention is to provide an image forming device that can automatically detect the location of the staple, binder clip, or other document fastener from image data for the front page of a bound original document; automatically set a document fastener or binding margin replacement area that is replaced according to the document fastener position, and set a replacement color that is the color of the mask data element replacing the data elements in the replacement area, based on image data for each page of the original document; and then copy each page by converting the data element in the replacement area portion of the original document image data to a mask data element of the replacement color.

### SUMMARY OF THE INVENTION

To achieve this object, an image forming device according to a preferred aspect of the invention has an original document scanning unit for imaging an original document and generating image data; a storage unit for storing image pattern data of document fasteners for binding original documents; a comparison means for comparing the image data with the image pattern data of the document fasteners; a position detection means for detecting the position of the document fastener in the image data when a pattern match is confirmed by the comparison means; and an image replacement means for substituting a predetermined mask data element for a data element of the predetermined replacement area portion of the image data to be replaced according to the position of the document fastener.

The data element of the document fastener area for which a match was confirmed by the comparison means is preferably used as the data element of the predetermined replacement area portion in this image forming device.

Furthermore, white is preferably used as the color of the predetermined mask data element in this image forming device.

An image forming device according to another aspect of the invention also has an operating unit for receiving a data input operation, and a color specification means for setting a color input from the operating unit in the image replacement means. In this arrangement the color input from the operating unit is used as the color of the predetermined mask data element.

An image forming device according to another aspect of the invention also has a neighboring color detection means for detecting a color of a data element in a predetermined area neighboring the predetermined replacement area portion of the image data to be replaced according to the position of the document fastener. In this arrangement the color of the data element in the predetermined area detected by the neighboring color detection means is used as the color of the predetermined mask data element.

An image forming device according to another aspect of the invention also has a background color detection means for detecting a background color of the original document image in the image data. In this arrangement the background color of the original document image detected by the background color detection means is used as the color of the predetermined mask data element.

An image forming device according to another aspect of the invention also has a dedicated mode for copying an original document that is bound by a document fastener by substituting a predetermined mask data element for a data element of a predetermined replacement area portion of the original document image data that is replaced according to the position of the document fastener.

When an original document that is bound by a document fastener is copied by an image forming device according to the invention, the data elements of the replacement area of the document fastener portion or binding margin portion of the original document image are replaced by mask data elements of the same color as the neighboring image areas. As a result, a nice, clean copy of the original document can be printed to paper.

### BRIEF DESCRIPTION OF THE DRAWINGS

FIG. 1 is a block diagram showing the major parts of a photocopier according to the present invention.

FIG. 2 is a vertical section view schematically showing the major parts of a photocopier according to the present invention.

FIG. 3 shows an example of the display area of the liquid crystal display.

FIG. 4 is a flow chart describing the copying process of the photocopier when copying an original document that is bound with a staple.

FIG. 5 shows the front page of a stapled original document.

FIG. 6A and FIG. 6B describe a method of detecting the location of a staple from the image data of the front page.

FIG. 7 describes the area within a predetermined distance X from the edges of the staple in the front page image.

FIG. 8 shows the liquid crystal display when an image of the front page is displayed.

FIG. 9 shows a page of an original document when the original document is folded back.

FIG. 10 describes a method of setting the replacement area when the corner portions of the original document are fastened together with a staple.

FIG. 11 describes a method of setting the replacement area when the original documents are fastened with a staple at the top of the page.

### DETAILED DESCRIPTION OF THE PREFERRED EMBODIMENTS

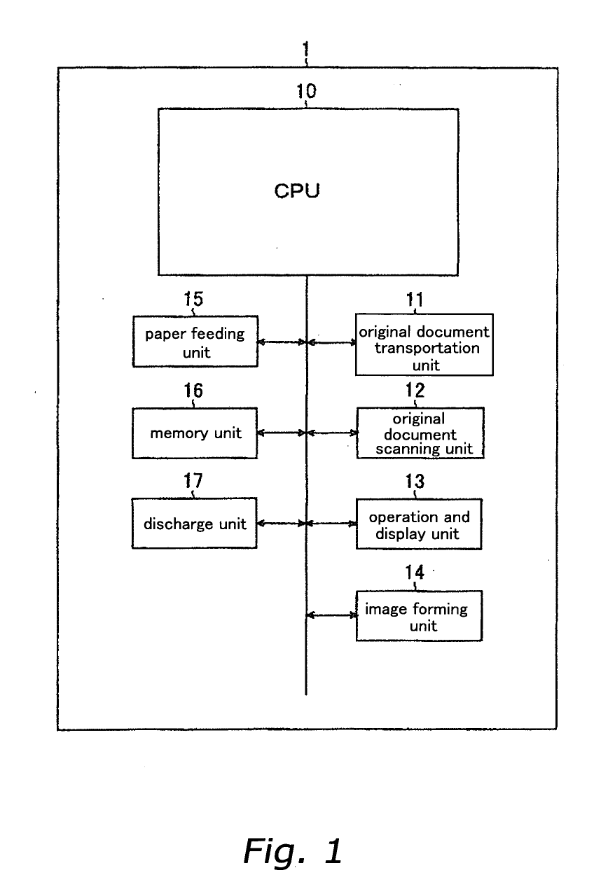

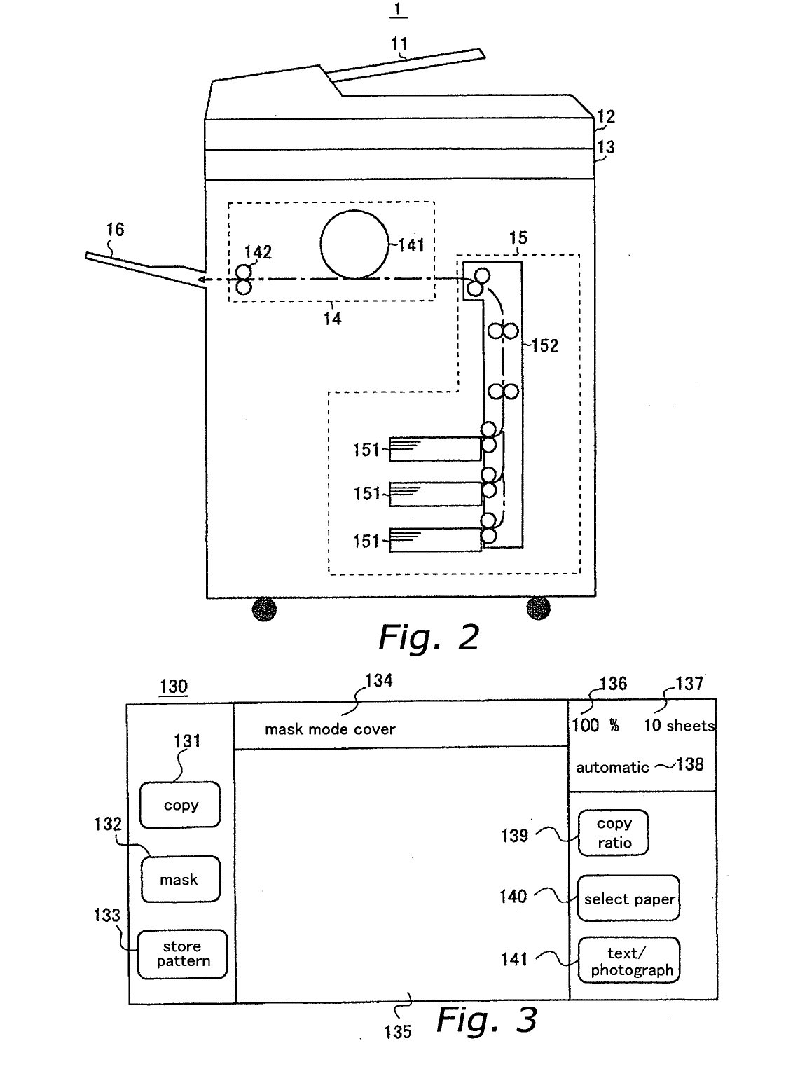

The present invention is described below using a photocopier by way of example. FIG. 1 is a block diagram showing the major parts of a photocopier according to the present invention, and FIG. 2 is a vertical section view schematically showing the major parts of a photocopier according to the present invention.

As shown in the figures, a photocopier 1 according to this embodiment of the invention has a central processing unit (CPU) 10 that controls overall operation of the image forming device; an original document transportation unit 11 for automatically conveying the original document; an original document scanning unit 12 for scanning the original document delivered from the original document transportation unit 11 and generating color image data; an operation and display unit 13 consisting of an operating means (such as a keypad or touch panel) and a display means (such as a liquid crystal display); an image forming unit 14 (including a print unit 141 consisting of a print head and photosensitive drum, and a fixing unit 142 for fixing the image output of the print unit 141 on paper) for forming a color or monochrome image on paper based on the image data; a paper feeding unit 15 for feeding paper to the image forming unit 14; a memory unit 16 consisting of ROM (Read Only Memory) in which control programs are stored, RAM (Random Access Memory) used as a working area, and pattern memory for storing image data for a plurality of image patterns of staples, binder clips, and other document fasteners; and a discharge unit 17 for receiving the discharged paper after image formation is completed.

In addition to controlling overall operation of the image forming device, the CPU 10 also performs a control process for automatically detecting the location of the document fastener binding an original document together from the image data of the front page of the bound original document; automatically setting a document fastener or binding margin replacement area that is replaced according to the document fastener position, and automatically setting a replacement color that is the color of the mask data element substituted for the data elements in the replacement area, based on image data for each page of the original document; and then copying each page by converting the data element in the replacement area portion of the original document image data with a mask data element of the replacement color.

The paper feeding unit 15 consists of a plurality (three in this embodiment of the invention) of paper storage units 151 from which paper is fed to the image forming unit 14, and a paper transportation unit 152 that is a common paper transportation path from each of the paper storage units 151 to the image forming unit 14.

As shown in FIG. 3, the operation and display unit 13 has a liquid crystal display 130 comprising a touch panel function. As shown in FIG. 3 by way of example, the liquid crystal display 130 presents a copy mode selection unit 131 that is pressed to select the photocopier function; a mask mode selection unit 132; a pattern registration selection unit 133; a status display unit 134 for displaying the operating status of the image forming device; a main display unit 135 on which guidance and other information is displayed; a copy ratio selection unit 139 for setting the copy ratio; a copy ratio display unit 136 for displaying the copy ratio set with the copy ratio selection unit 139; a copy count display unit 137 for displaying the number of copies that is set using a keypad not shown; a paper size selection unit 140 for selecting the size of paper used for printing or the method of selecting the paper size; a paper display unit 138 for displaying the paper size or paper size selection method selected with the paper size selection unit 140; and a copy quality selection unit 141 for selecting the image quality mode to be used for copying.

The mask mode selection unit 132 is pressed to select the function for replacing the image of the document fastener or binding margin part with a predetermined image when copying original documents that are fastened together with a document fastener, and copying the original document so that the image of the document fastener or binding margin part is blended with the image of the surrounding area and rendered inconspicuous.

The pattern registration selection unit 133 is pressed to register a document fastener pattern for a new type of staple or binder clip, for example.

The operation whereby the photocopier 1 comprised as described above copies loose, unbound original documents in the normal copy mode is described next below. The original document copying operation of this photocopier 1 starts by conveying the original document from the original document transportation unit 11 to the original document scanning unit 12. The original document scanning unit 12 then scans a color image of the original document (generates image data). The resulting image data is temporarily stored to memory unit 16, and then read from memory and passed to the image forming unit 14. The image forming unit 14 then performs an image forming process and fixing process on the paper based on the input image data.

The copying process according to the present invention whereby the photocopier 1 of this embodiment copies an original document that is held together by a document fastener: detects the location of the staple, binder clip, or other document fastener from image data for the front page of the bound original document; automatically sets a document fastener or binding margin replacement area that is replaced according to the document fastener position, and sets a replacement color that is the color of the mask data element that replaces the data elements in the replacement area, based on image data for each page of the original document; and then copies each page by converting the data element in the replacement area portion of the original document image data to a mask data element of the replacement color.

The operation whereby a photocopier 1 according to this embodiment of the invention copies a bound original document is described in detail next below with reference to the accompanying figures. This copying operation is performed in a special copying mode referred to herein as a “mask mode.” The copying operation described below assumes that the original documents are bound by a staple.

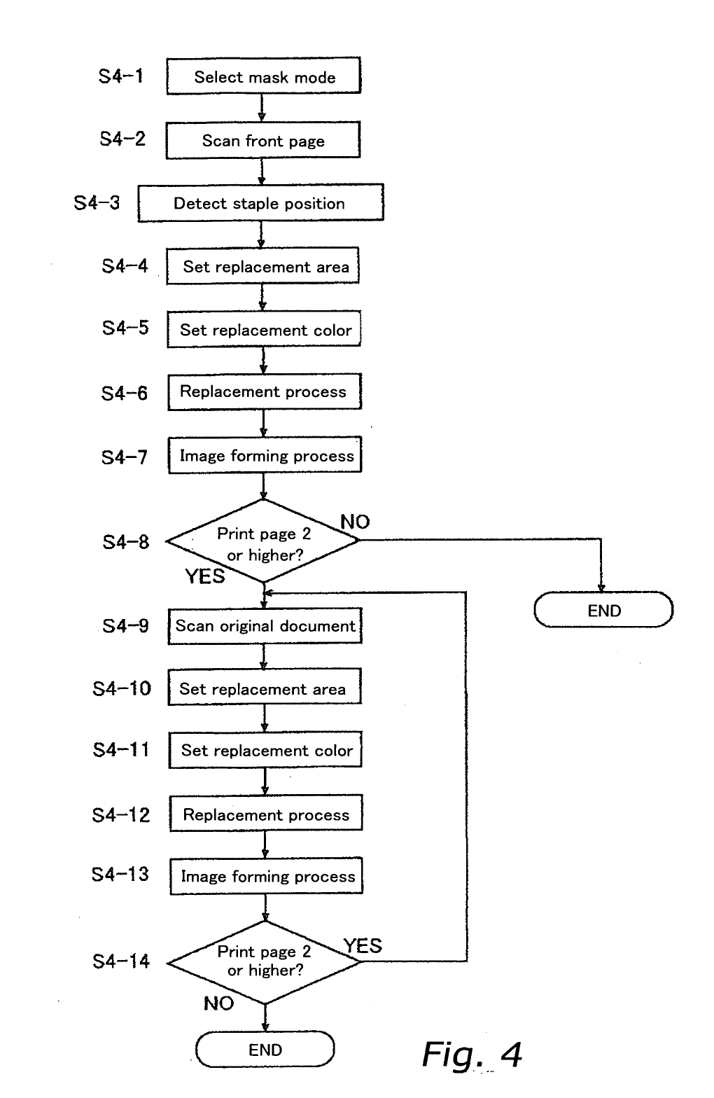

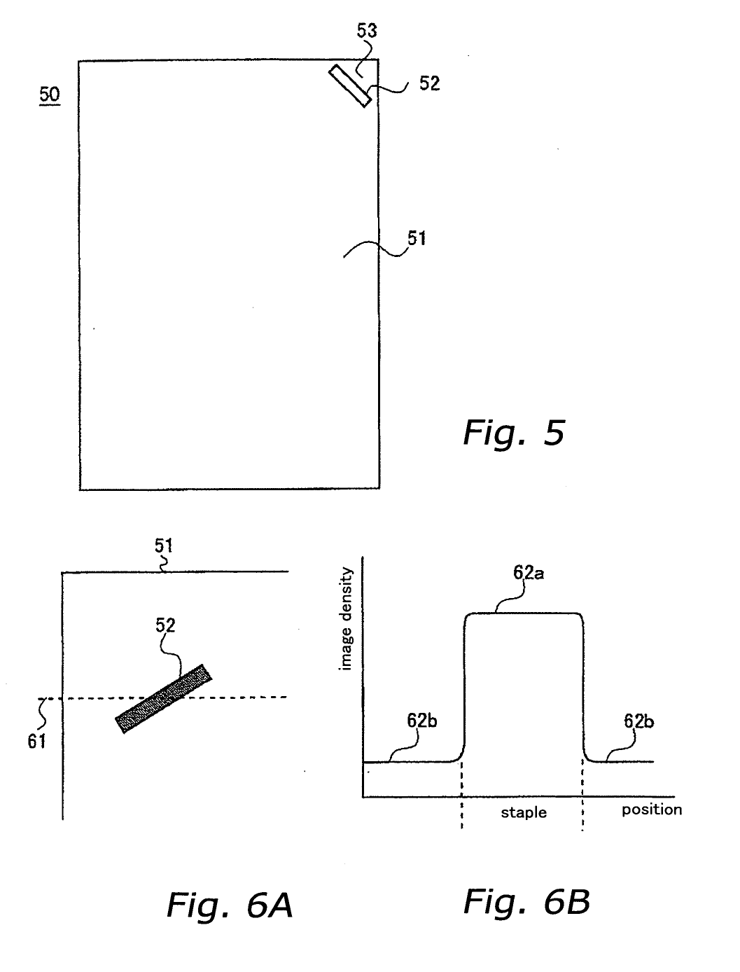

FIG. 4 is a flow chart describing the copying operation of the photocopier 1 when copying an original document bound together by a staple. FIG. 5 shows the front page of an original document that is held together by a staple. As shown in FIG. 1 to FIG. 5, when the mask mode is selected by pressing the mask mode selection unit 132 in step S4-1 in a photocopier 1 according to this embodiment of the invention, a message is displayed to tell the user that the mask mode is selected and the front page 51 of an original document 50 that is bound by a staple 52 in corner portion 53 will be copied.

In step S4-2, the front page 51 of the original document 50 bound by a staple 42 is placed at a predetermined position on the original document scanning glass (not shown) of the original document scanning unit 11 with the print side facing the scanning glass. After entering the number of copies, for example, and then pressing the start button (not shown) on the operation and display unit 13, the original document scanning unit 11 images the front page 51. After the CPU 10 determines the size of the original document, the image data for the front page 51 is stored in memory unit 16.

In step S4-3, the CPU 10 reads the image data for the front page 51 stored in the memory unit 16, and detects the location of the staple 52 as described below.

FIG. 6A is an enlarged view of the image area around the staple 52 in the image data of the front page 51. FIG. 6B is a graph of the image density near the staple along the dotted line 61 in FIG. 6A. As shown in FIG. 6A, the image near the staple 52 in the image data of the front page 51 contains an image representing the shape of the staple 52 and an image of the background surface of the paper. As shown in FIG. 6B, there is a significant difference in the image density along dotted line 61 in FIG. 6A between image level a 62a in the image of the staple 52 and the surrounding image level b 62b. These image levels and this image level difference continue throughout the image area of the staple 52 shown in FIG. 6A. The continuous points along the boundary between image level a 62a and image level b 62b define the shape of the staple 52 or the approximate shape of the staple 52. This is used to extract data for symbols, text, and other shapes from the image data of the front page 51. The CPU 10 then compares this shape data extracted from the image data of the front page 51 with all staple patterns stored in the memory unit 16. If this comparison determines that the image data of the front page 51 contains a staple 52 matching a staple pattern, the CPU 10 detects the position and shape of the staple 52 matching the staple pattern in the image data of the front page 51. Data denoting the position and shape of the staple 52 are then stored in memory unit 16. Note that the position of the staple 52 can be detected using a different known method.

If the position of the staple 52 is not detected, an appropriate message is displayed on the main display unit 135. A new staple pattern can be stored as described below.

When the pattern registration selection unit 133 is pressed, an image of the front page 51 is displayed on the main display unit 135 as shown in FIG. 3 so that the location of the staple 52 can be registered using a stylus, for example, and the new staple pattern is then added to the memory unit 16.

Based on the result of detecting the position of the staple 52, the detected area of the staple 52 in the image data of the front page 51 is automatically set in step S4-4 as the replacement area that is replaced by the mask data element. The replacement area is preferably set to a size sufficient to hide the staple 52.

The replacement color, which is the color of the mask data element that is substituted for the data element of the staple area in the image data of the front page 51, is set automatically in step S4-5 as described below.

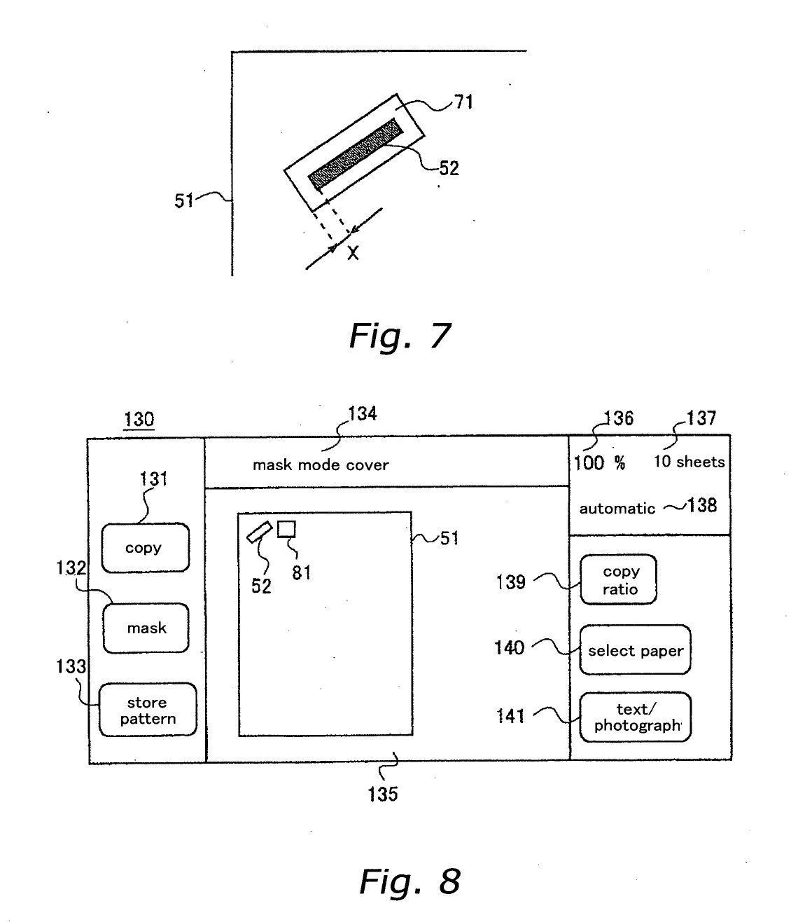

FIG. 7 describes the area within predetermined distance X from the edges of the staple 52 in the front page image. Referring to FIG. 7, the CPU 10 reads the image data of the front page 51 and information such as the position and shape of the detected staple 52 from the memory unit 16. The CPU 10 then extracts the area 71 within predetermined distance X from the edges of the staple 52 and samples the image data in area 71 from the image data for the front page 51, and sets the color denoting the average of the sampled image data as the replacement color.

Alternatively, the CPU 10 can detect the background color of the front page 51 from the image data for the front page 51 and set this detected color as the replacement color. The background color of the front page 51 can be detected using various methods known from the literature, including detecting the most frequently occurring color in the scanned image data of the front page 51 and using this color as the background color of the front page 51.

Further alternatively, white could be set as the replacement color because original documents with a white background are commonly used.

The replacement color can also be set as described below. FIG. 8 shows the liquid crystal display 130 when displaying an image of the front page 51. As shown in FIG. 8, an image of the front page 51 containing an image of the staple 52 is displayed in the main display unit 135 of the liquid crystal display 130. An area 81 within the area of the displayed front page 51 on the screen is then defined by touch the screen, and the CPU 10 samples the image data in the area 81 thus specified in the image of the front page 51. The sampled image data is then averaged, and the average color of the sampled image data is automatically set as the replacement color.

In step S4-6, the data elements in the staple 52 area part of the image data for the front page 51 are then replaced by mask data elements of the replacement color set in step S4-5.

In step S4-7, an image of the front page after the data elements are thus replaced is formed on paper by the image forming unit 14 based on the substituted image data for the front page 51, and the copy is discharged to the discharge unit 17. By thus removing the image of the staple 52 from the image of the front page formed on the paper, a nice, clean copy of the front page can be printed. Control then advances to step S4-8 after printing the previously set number of copies.

In step S4-8, a message asking if the original document on page 2 or later is to be copied is displayed on the main display unit 135. If more pages are not to be copied (S4-8 returns No), the Stop button displayed on the main display unit 135 is pressed and this process ends. If the original document on page 2 or later is to be copied (S4-8 returns Yes) and the Copy button displayed on the main display unit 135 is therefore pressed, a message indicating that page 2 or later will be copied is displayed in the status display unit 134 and control goes to step S4-9.

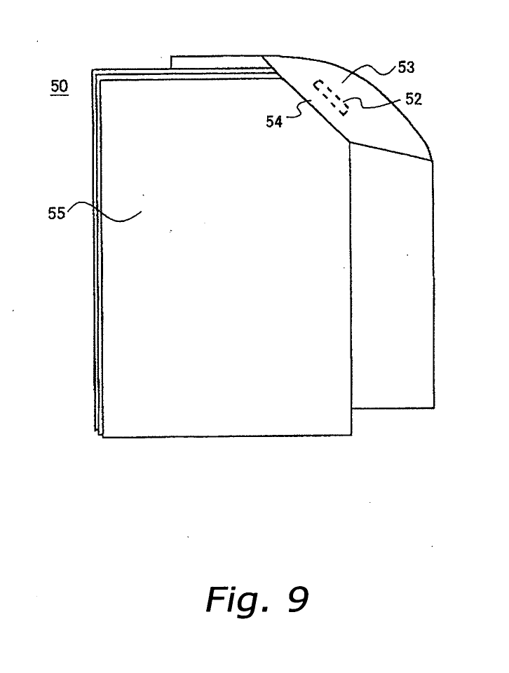

The original document on page two or later is then scanned in step S4-9 by the original document scanning unit 11 as described below. FIG. 9 shows the original document for a page of an original document 50 having one or more pages folded back. As shown in FIG. 9, the original document 55 to be copied is opened by folding back to the outside one or more pages of an original document 50 that is fastened at the corner portion 53 by a staple 52. The original document 55 with a binding margin 54 in the corner portion 53 is then placed with the printed side facing the scanning glass (not shown) of the original document scanning unit 11 in the same position and orientation used to scan and copy the front page. After then entering the number of copies and pressing the start key (not shown), the original document scanning unit 11 images the original document 55, detects the size and position of the original document, and then stores the image data for the original document 55 together with such information as the size and position of the original document in the memory unit 16.

Based on the position of the staple 52 determined in step S4-3, the area containing the binding margin 54 in the image data for the original document 55 is automatically set as the replacement area in step S4-10 as described below so that the scanned image of the binding margin 54 of the original document 55 is not printed to paper.

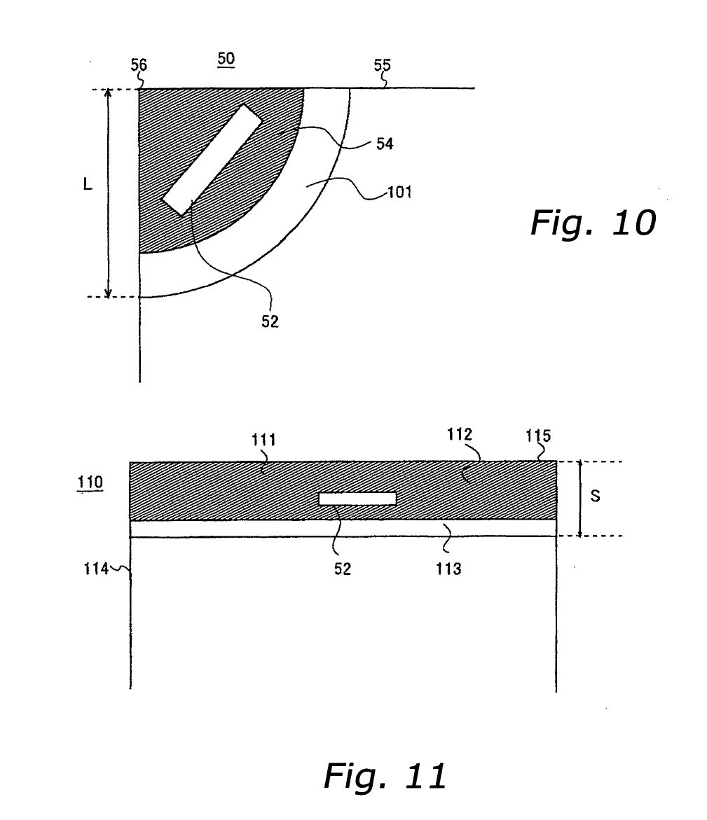

FIG. 10 describes a method of setting the replacement area when the corner portion 53 of the original document 50 is fastened by a staple 52.

When the corner portion 53 of the original document 50 is fastened by a staple 52 as shown in FIG. 9 and FIG. 10 and the position of the staple 52 is detected in step S4-3, the CPU 10 determines that the corner portion 53 is fastened with a staple 52 if the position of the staple 52 is within a predetermined range near the corner portion 53. To prevent this binding margin 54 part from being printed, the area to a position at a predetermined distance further separated from the position of the part of the staple 52 that is farthest from the corner 56 of the original document 55 is automatically set as the replacement area. More specifically, the quarter circle area 101 of radius L from the corner 56 of the original document 55, which is an area large enough to cover the binding margin 54, is automatically set as the replacement area. Note that an area larger than the binding margin 54 or an area equal to the binding margin 54 can be automatically set as the replacement area based on the position of the staple 52.

A method of setting the replacement area when the top part of the original document is fastened by a staple 52 is described next. FIG. 11 describes this method of setting the replacement area when the top part of the original document is fastened by a staple 52.

When the top part 111 of the original document 110 is fastened by a staple 52 as shown in FIG. 10, and the position of the staple 52 is detected in step S4-3, the CPU 10 determines that the original document is held by a staple 52 in the top part 111 if the position of the staple 52 is within a predetermined range near the top part 111. To prevent an image of this binding margin 112 from being printed, the area to a position at a predetermined distance further separated from the position of the staple 52 that is farthest in the perpendicular direction from the top part 111 of the original document 114 that is folded open is automatically set as the replacement area. More specifically, the rectangular area 113 to distance S from the top edge 115 of the original document 114 is automatically set as the replacement area. Note that an area larger than the binding margin 112 or an area equal to the binding margin 112 can be automatically set as the replacement area.

In step S4-11, the replacement color, which is the color of the mask data element substituted for the data elements in the replacement area part 101 of the image data for the original document 55, is automatically set to the same color set in step S4-5. Alternatively, the replacement color can be set automatically by detecting the color of the background or the image data near the binding margin 54 from the image data of the original document 55 using a method such as described above.

In step S4-12, the data elements in the replacement area 101 portion of the image data for the original document 55 are then replaced by the mask data elements of the replacement color set in step S4-11.

In step S4-13, an image of the original document is formed on paper by the image forming unit 14 based on the image data of the original document after data element substitution, and the copy is then discharged to the discharge unit 17. By thus removing the image of the binding margin 54 from the image of the original document formed on the paper, a nice, clean copy of the original document can be printed. Control then advances to step S4-14 after printing the previously set number of copies.

In step S4-14, a message asking if the original document on page 2 or later is to be copied is displayed on the main display unit 135. If more pages are not to be copied (S4-14 returns No), the Stop button displayed on the main display unit 135 is pressed and this process ends. If the original document on a different page is to be copied (S4-14 returns Yes) and the Copy button displayed on the main display unit 135 is therefore pressed, control loops back to step S4-9 and this operation repeat.

As described above, when an original document that is fastened by a staple, binder clip, or other document fastener is copied by the photocopier 1 according to this embodiment of the invention, the image of the document fastener portion or binding margin portion is automatically replaced by an image of the same color as the image neighboring the document fastener portion or binding margin portion. As a result, a nice, clean image of the original document from which the document fastener portion or binding margin portion has been removed can be printed to paper.

The present invention provides useful technology for improving the quality of images copied from original documents that are bound by a staple, binder clip, or other document fastener, and can be applied to image forming devices, such as facsimile machines, other than photocopiers.

What is claimed is:

1. An image forming device comprising:
an original document scanning unit for imaging an original document and generating image data;
a storage unit for storing image pattern data of document fasteners for binding original documents;
a comparison means for comparing the image data with the image pattern data of the document fasteners;
a position detection means for detecting a position of the document fastener in the image data when a pattern match is confirmed by the comparison means; and
an image replacement means for replacing a data element of a predetermined replacement area portion of the image data to be replaced according to the position of the document fastener with a predetermined mask data element.

2. The image forming device according to claim 1, wherein the data element of the predetermined replacement area portion is the data element of the document fastener area for which a match was confirmed by the comparison means.

3. The image forming device according to claim 1, wherein the color of the predetermined mask data element is white.

4. The image forming device according to claim 1, further comprising:
an operating unit for receiving a data input operation; and
a color specification means for setting a color input from the operating unit in the image replacement means;
wherein the color of the predetermined mask data element is the color input from the operating unit.

5. The image forming device according to claim 1, further comprising:
a neighboring color detection means for detecting a color of a data element in a predetermined area neighboring the predetermined replacement area portion of the image data to be replaced according to the position of the document fastener;
wherein the color of the predetermined mask data element is the color of the data element detected in the predetermined area by the neighboring color detection means.

6. The image forming device according to claim 1, further comprising:
a background color detection means for detecting a background color of the original document image from the image data;
wherein the color of the predetermined mask data element is the background color of the original document image detected by the background color detection means.

7. The image forming device according to claim 1, further comprising:
a dedicated mode for copying an original document that is bound by a document fastener by substituting a predetermined mask data element for a data element of a predetermined replacement area portion of the original document image data that is replaced according to the position of the document fastener.
